(19) United States
(12) Patent Application Publication
(10) Pub. No.: US 2026/0254524 A1
(43) Pub. Date: Aug. 27, 2026

(54) METHODS AND SYSTEMS FOR INTEGRATING SATELLITE AND TERRESTRIAL RADIO COMMUNICATION

(71) Applicant: SAUDI ARABIAN OIL COMPANY, Dhahran (SA)

(72) Inventors: Ahmad F. Alotaibi, Khobar (SA); Khalid H. Hajri, Abqaiq (SA); Hussain A. Salman, Khobar (SA); Sari M. Handhah, Khobar (SA); Abdullah I. Sowailem, Abqaiq (SA)

(73) Assignee: SAUDI ARABIAN OIL COMPANY, Dhahran (SA)

(21) Appl. No.: 19/062,614

(22) Filed: Feb. 25, 2025

(51) Int. Cl. H04B 7/185; H04W 56/00

(52) U.S. Cl. CPC H04B 7/185; H04W 56/003

(57) ABSTRACT

A system includes a satellite communication device and a radio communication device, where each is configured to receive a communication signal. The system further includes a first actuator, a second actuator and a microcontroller. The microcontroller is configured to determine whether the communication signal is received by the satellite communication device or by the radio communication device. In response to the former, the microcontroller is configured to activate the second actuator to press a send button on the radio communication device to transmit the communication signal from the satellite communication device to the radio communication device. In response to the latter, the microcontroller is configured to activate the first actuator to press a send button on the satellite communication device to transmit the communication signal from the radio communication device to the satellite communication device.

### BACKGROUND

It is generally not possible to communicate between satellite communication systems and terrestrial radio communication systems. Although both systems communicate through radio signals, the particular frequency bands allocated for satellite communication and terrestrial radio networks, respectively, are regulated to be separate. Moreover, the signal strength required to communicate with satellites is substantially more than typically can be achieved by terrestrial radio systems. The incompatibility of satellite communication systems and radio communication systems poses a challenge for communicating between locations where only one or the other method is available. For example, many oil and gas offshore and onshore rigs are not equipped for terrestrial radio communication systems due to the high mobility of the rigs. At these rigs, the only available method of communicating with other rigs is through purely wireless solutions relying on satellite communication systems. On the other hand, oil and gas processing plants are fixed facilities that support physical media connections (e.g., fiber optics and copper communication lines). As a result, radio base stations can be installed at plants. Communicating between such oil and gas rigs, equipped with satellite communication systems, and the processing plants, equipped with radio communication systems, is difficult.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a system. The system includes a satellite communication device and a radio communication device, where the radio communication device and the satellite communication device are each configured to receive a communication signal. The system further includes a first actuator mechanically coupled to the satellite communication device, a second actuator mechanically coupled to the radio communication device and a microcontroller. The microcontroller is configured to determine whether the communication signal is received by the satellite communication device or by the radio communication device. In response to the determination that the communication signal is received by the satellite communication device, the microcontroller is configured to activate the second actuator to press a send button on the radio communication device to transmit the communication signal from the satellite communication device to the radio communication device and transmit the communication signal from the satellite communication device to the radio communication device. In response to the determination that the communication signal is received by the radio communication device, the microcontroller is configured to activate the first actuator to press a send button on the satellite communication device to transmit the communication signal from the radio communication device to the satellite communication device and transmit the communication signal from the radio communication device to the satellite communication device.

Embodiments disclosed herein generally relate to a method. The method includes receiving a communication signal by either a satellite communication device or a radio communication device and determining whether the communication signal is received by the satellite communication device or by the radio communication device. In response to the determination that the communication signal is received by the radio communication device, the method further includes activating a first actuator to press a send button on the satellite communication device to transmit the communication signal from the radio communication device to the satellite communication device and transmitting the communication signal from the radio communication device to the satellite communication device. In response to the determination that the communication signal is received by the satellite communication device, the method also includes activating a second actuator to press a send button on the radio communication device to transmit the communication signal from the satellite communication device to the radio communication device and transmitting the communication signal from the satellite communication device to the radio communication device.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts locations using satellite and radio communication methods in accordance with one or more embodiments of the disclosure.

FIG. 2 depicts a system in accordance with one or more embodiments of the disclosure.

FIG. 3 depicts a computing system in accordance with one or more embodiments of the disclosure.

FIG. 4 depicts a flowchart in accordance with one or more embodiments of the disclosure.

### DETAILED DESCRIPTION

Specific embodiments of the present disclosure will now be described in detail below with reference to the accompanying drawings. Like elements in the various figures are denoted by like reference numerals for consistency.

In the following detailed description of embodiments of the disclosure, numerous specific details are set forth to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (e.g., any noun in the application). The use of ordinal numbers is not intended to imply or create a particular ordering of the elements nor to limit any element to being only a single element unless expressly disclosed, such as using the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

Satellite communication systems are typically used to communicate with remote locations where radio base stations cannot be built. These systems use regulated frequency bands (e.g., L-band 1-2 GHz, and S-band 2-4 GHz) and require powerful signals to reach satellites in orbit around Earth. By contrast, at more accessible locations, radio base stations can be built to provide access to terrestrial radio communication networks. Terrestrial radio communications networks use their own regulated frequency bands, depending on the use (e.g., 1900 MHz for 4G LTE networks, or 400-470 MHz for widely used public safety, commercial, and amateur radio networks). Transmitting signals across terrestrial radio networks requires less power due to the abundance of radio towers.

Communicating between remote locations that use satellite communication systems and more accessible locations that use terrestrial radio communication systems typically requires the use of a communication midpoint equipped with both satellite communication systems and terrestrial radio communication systems. The traditional solution is to employ an operator at the communication midpoint to manually receive signals from one communication system or the other, record the message, and then manually transmit the message through the other communication system. Consequently, there may be a delay in the communication and there is no guarantee that the information to be transmitted is well preserved and accurate. In general, in one aspect, embodiments of the present disclosure provide alternative methods and systems for communication between satellite communication systems and radio communication systems.

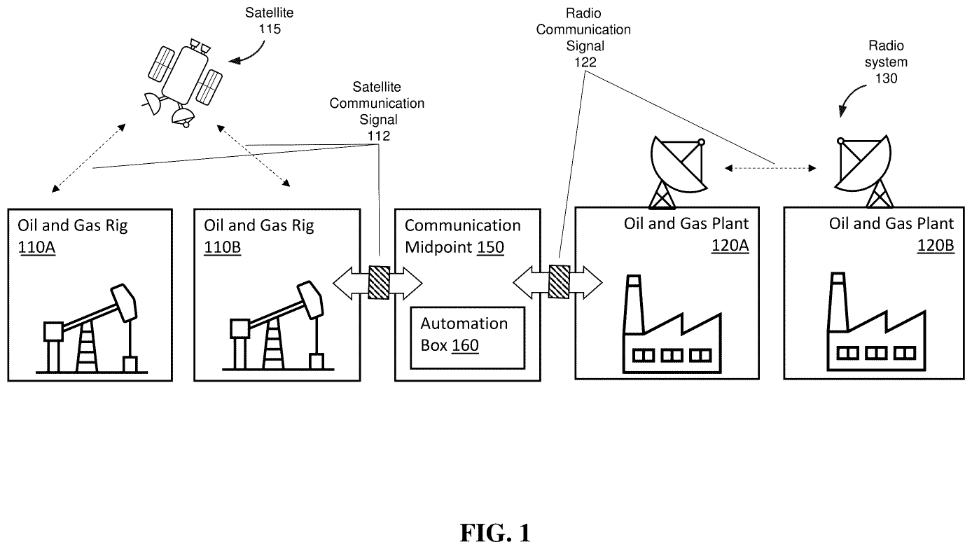

FIG. 1 depicts locations using satellite and radio communication methods and systems, in accordance with one or more embodiments. More specifically, FIG. 1 depicts two oil and gas rigs (110A, 110B) that communicate with each other using satellite communication signals (112) transmitted to and from a satellite (115). In addition, FIG. 1 depicts two oil and gas plants (120A, 120B) that communicate with each other using radio communication signals (122) transmitted between a radio system (130). Although both radio communication signals (122) and satellite communication signals (112) are technically both signals that use radio frequencies, it will be understood by a person of ordinary skill in the art that a satellite communication signal (112) refers to a signal within the frequency bands typically used for satellite communications (e.g., the “L-band”, between 1-2 GHz, or the S-band, between 2-4 GHz). Similarly, it will be understood by a person of ordinary skill in the art that the radio communication signals (122) are within the frequency bands typically used for terrestrial radio communication (e.g., for cellular communication, specific frequency bands between 600 MHz and for some 5G-capable systems, 24-48 GHz; for handheld radio devices, specific frequency bands between 65 MHz and 500 MHz).

The oil and gas rigs (110A, 110B) may be on shore or offshore and have communication access to a satellite (115), and the oil and gas plants (120A, 120B) may be located anywhere with access to radio base stations (130). Although FIG. 1 depicts oil and gas rigs (110A, 110B), a person of ordinary skill in the art will understand that embodiments of the present disclosure are not limited to oil and gas rigs (110, 110B) but are also applicable to other types of locations that communicate using satellite communication signals (112). Similarly, although FIG. 1 depicts oil and gas plants (120A, 120B), a person of ordinary skill in the art will understand that embodiments of the present disclosure are not limited to oil and gas rigs (110A, 110B) but are also applicable to other types of locations that communicate using radio communication signals (122).

In addition, although only two oil and gas rigs (110A, 110B) are depicted in FIG. 1, a person of ordinary skill in the art will appreciate that embodiments of the present disclosure are not limited by the number of locations that communicate using satellite communication signals (112). Likewise, although only two oil and gas plants (120A, 120B) are depicted in FIG. 1, a person of ordinary skill in the art will appreciate that embodiments of the present disclosure are not limited by the number of locations that communicate using radio communication signals (122). However, the minimum requirement is at least one location that is accessible for communication through satellite communication signals (112) and at least one location that is accessible for communication through radio communication signals (122).

As discussed, the satellite communication systems, such as those used to transmit satellite communication signals (112) between the oil and gas rigs (110A, 110B), are not able to directly communicate with the radio communication systems, such as those used to transmit radio communication signals (122) between the oil and gas plants (120A, 120B). Instead, the signals are passed through a communication midpoint (150). The communication midpoint (150) is equipped to transmit and receive both satellite communication signals (112) and radio communication signals (122). Consequently, a message may be sent from one of the oil and gas plants (e.g., oil and gas plant (120A)) to the communication midpoint (150). From there, the signal may be sent from the communication midpoint (150) to one of the oil and gas rigs (e.g., oil and gas rig (110B)). Although in FIG. 1, the communication midpoint (150) is shown as transmitting signals between oil and gas rig (110B) and oil and gas plant (120A), a person of ordinary skill in the art will understand that the communication midpoint (150) may be used to transmit signals between any of the locations.

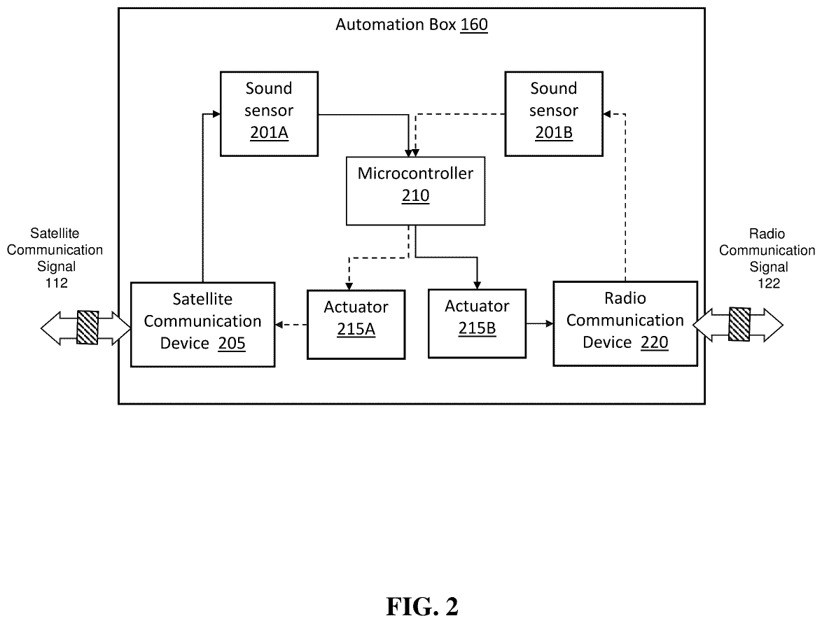

In accordance with one or more embodiments, the communication midpoint communicates with both satellite communication systems and radio communication systems through the use of an automation box (160). The automation box is illustrated in FIG. 2. The automation box (160) is used to send and receive both satellite communication signals (112) and radio communication signals (122). For the transmission and receipt of satellite communication signals (112), the automation box (160) includes a satellite communication device (205). The satellite communication device (205) may be any consumer or commercially available satellite communication device, for example, a satellite phone. In addition to being configured to transmit and receive satellite communication signals (112), the satellite communication device (205) may have a microphone to receive audio signals and a speaker for projecting audio signals. For transmission and receipt of radio communication signals (122), the automation box (160) includes a radio communication device (220). The radio communication device may be any consumer or commercially available satellite communication device, for example, a handheld radio. In addition to being configured to transmit and receive radio communication signals (122), the radio communication device (220) may have a microphone to receive audio signals and a speaker for projecting audio signals.

A microcontroller (210) is configured to determine whether a communication signal is received by the satellite communication device (205) or by the radio communication device (220). In one or more embodiments, the microcontroller (210) is electronically coupled to a sound sensor (201A, 201B) disposed in proximity to the satellite communication device (205) and the radio communication device (220). When a communication signal (i.e., a satellite communication signal (112) or a radio communication signal (122)) is received at the automation box (160), the receiving device (i.e., the satellite communication device (205) or the radio communication device (220)) may project the signal as an audio signal through its speaker. At that time, the sound sensor (201A, 201B) may detect the audio signal, and the microcontroller (210) may determine that a communication signal has been received by either the satellite communication device (205) or the radio communication device (220) based on the detection by the sound sensor (201A, 201B).

The automation box (160) may use one sound sensor (e.g., sound sensor (201A) or sound sensor (201B)) to determine whether the communication signal was specifically received by the satellite communication device (205) or the radio communication device (220). For example, in one or more embodiments, the audio signal that is projected from the speaker of either the satellite communication device (205) or radio communication device (220) may begin with a tone of a particular frequency the identifies the signal as being projected from the satellite communication device (205) or from the radio communication device (220). The microcontroller (210) may be configured to consider the tone at the beginning of the audio signal, detected by one sound sensor (e.g., sound sensor (201A) or sound sensor (201B)), to determine whether the signal was received and then projected by the satellite communication device (205) or instead received and then projected by the radio communication device (220). In one or more embodiments, an audio signal that is projected from the speaker of the satellite communication device (205) may have a different frequency compared to an audio signal projected from the speaker of the radio communication device (220). The microcontroller (210) may be configured to consider the frequency of the audio signal to determine whether the signal was received and then projected by the satellite communication device (205) or instead received and then projected by the radio communication device (220).

In one or more embodiments, the automation box (160) may use two sound sensors, a first sound sensor (201A) and a second sound sensor (201B), to determine whether the communication signal was specifically received by the satellite communication device (205) or the radio communication device (220). For example, the first sound sensor (201A) may be disposed nearer to the satellite communication device (205) than to the radio communication device (220), and the second sound sensor (201B) may be disposed nearer to the radio communication device (220) than to the satellite communication device (205). An audio signal that is projected by the speaker of the satellite communication device (205) will be detected by the first sound sensor (201A) before it is detected by the second sound sensor (201B). Similarly, an audio signal that is projected by the speaker of the radio communication device (220) will be detected by the second sound sensor (201B) before it is detected by first sound sensor (201A). Therefore, the automation box (160) may use the two sound sensors as follows for determining which device received and then projected the communication signal. The microcontroller (210) may record a first time stamp indicating a first moment in time that the first sound sensor (201A) detects the audio signal and a second time stamp indicating a second moment in time that the second sound sensor (201B) detects the audio signal. Then, the microcontroller (210) may determine whether the first time stamp is earlier or later than the second time stamp. In response to the determination that the first time stamp is earlier than the second time stamp, the microcontroller may determine that the communication signal is received (and then projected) by the satellite communication device (205). Similarly, in response to the determination that the first time stamp is later than the second time stamp, the microcontroller may determine that the communication signal is received (and then projected) by the radio communication device (220).

In some instances, a communication signal may be received by the satellite communication device (205) and separate communication signal may be received by the radio communication device (220) at substantially the same time (e.g., within 0.1-1 second of one another). In these instances, the microcontroller (210) may be configured to designate either the satellite communication device (205) or the radio communication device (220) as having higher priority. Accordingly, if it cannot be determined which communication device (205, 220) received a communication signal first, the microcontroller (210) will default to selecting the prioritized communication device as the communication device that first received the communication signal.

In one or more embodiments, the microcontroller (210) is electronically coupled to a light detector, for example, a photodiode, phototransistor, or camera. The microcontroller may be electronically coupled to one or more light detectors. When a communication signal is received by the satellite communication device (205) or the radio communication device (220), the communication device (205, 220) may turn on a light to indicate that a signal was received. The microcontroller (210) may then use the light detector or light detectors to determine which communication device (205, 220) turned on a light and therefore received a communication signal. In one or more embodiments, the microcontroller (210) is electronically coupled to a vibration detector, such as an accelerometer, a gyroscope, a microelectromechanical systems (MEMS) sensor, or a piezoelectric sensor. The microcontroller may be electronically coupled to one or more vibration detectors. When a communication signal is received by the satellite communication device (205) or the radio communication device (220), the communication device (205, 220) may vibrate to indicate that a signal was received. The microcontroller (210) may then use the vibration detector or vibration detectors to determine which communication device (205, 220) vibrated and therefore received a communication signal.

Inside the automation box (160), a first actuator (215A) is mechanically coupled to the satellite communication device (205), and a second actuator (215B) is mechanically coupled to radio communication device (220). The actuators (215A, 215B) are controlled by the microcontroller (210). In response to the determination that the communication signal is received by the satellite communication device (205), the microcontroller (210) activates the first actuator (215A) to press a “send” button on the radio communication device (220) to transmit the communication signal from the satellite communication device (205) to the radio communication device (220). Then, the communication signal is transmitted from the satellite communication device (205) to the radio communication device (220). Similarly, in response to the determination that the communication signal is received by the radio communication device (220), the microcontroller (210) activates the second actuator (215B) to press a “send” button on the satellite communication device (205) to transmit the communication signal from the radio communication device (220) to the satellite communication device (205). Then, the communication signal is transmitted from the radio communication device (220) to the satellite communication device (205).

In accordance with one or more embodiments, the sound sensor(s) (201A, 201B) and the actuators (215A, 215B) may be controlled with either wired or wireless connections. Wireless communication may be supported through a Wi-Fi communication network, a Bluetooth communication network, or another remote communication method such as radio-frequency communication over a predefined frequency channel.

In one or more embodiments, the communication signal is a voice signal or is processed by one of the communication devices (205, 220) into a voice signal after it is received. Transmitting the voice signal from the satellite communication device (205) to the radio communication device (220) may include projecting the voice signal from the speaker of the satellite communication device (205) into a microphone of the radio communication device (220). The microphone of the radio communication device (220) may be turned on by pressing the “send” button on the radio communication device (220) using the second actuator (215B), after the microcontroller (210) has determined that a communication signal is received by the satellite communication device (205). Similarly, transmitting the voice signal from the radio communication device (220) to the satellite communication device (205) may include projecting the voice signal from the speaker of the radio communication device (220) into a microphone of the satellite communication device (205). The microphone of the satellite communication device (205) may be turned on by pressing the “send” button on the satellite communication device (205) using the first actuator (215A), after the microcontroller (210) has determined that a communication signal is received by the radio communication device (220). The same may be applied to any other type of audio signal that is projected from the speaker of the satellite communication device (205) or the speaker of the radio communication device (220).

In one or more embodiments, the audio signal projected from the speaker of the satellite communication device (205) or the speaker of the radio communication device (220) may be maintained or enhanced using voice-isolated material (e.g., acoustic panels, soundproofing foam, etc.) to prevent interference from the surrounding environment. Alternatively, or in addition, Quality of Service (QoS) techniques may be applied to the predetermined frequency channels used by the satellite communication device (205) or the radio communication device (220). QoS techniques manage network resources to ensure the performance of the communication signals and include adaptive bandwidth allocation and data type prioritization.

In accordance with one or more embodiments, the solid black arrows in FIG. 2 illustrate the order of steps after receiving a communication signal to the satellite communication device (205), which include, but are not necessarily limited to, the following. A satellite communication signal (112) is received by the satellite communication device (205). In accordance with one or more embodiments, the communication signal is an audio signal, or is processed by the satellite communication device (205) into an audio signal, such as a voice signal. The voice signal is projected from the speaker of the satellite communication device (205). The first sound sensor (201A) detects the voice signal before the second sound sensor (201B), and therefore the microcontroller (210) determines that a communication signal is received by the satellite communication device (205). Alternatively, or in addition, one of the other methods described above for determining that the satellite communication device (205) received the communication signal may be used. Subsequently, the microcontroller (210) activates the second actuator (215B) to press the “send” button on the radio communication device (220), turning on the microphone of the radio communication device (220). The communication signal is then transmitted from the satellite communication device (205) to the radio communication device (220) by continuing to project the voice signal from the speaker of the satellite communication device (205) into the microphone of the radio communication device (220). Afterwards, the radio communication device (220) transmits the communication signal, received from the satellite communication device (205), to another physically distant radio communication device.

In accordance with one or more embodiments, the dashed black arrows in FIG. 2 illustrate the order of steps after receiving a communication signal to the radio communication device (220), which include, but are not necessarily limited to, the following. A radio communication signal (122) is received by the radio communication device (220). In accordance with one or more embodiments, the communication signal is an audio signal, or is processed by the radio communication device (220) into an audio signal, such as a voice signal. The voice signal is projected from the speaker of the radio communication device (220). The second sound sensor (201B) detects the voice signal before the first sound sensor (201A), and therefore the microcontroller (210) determines that a communication signal is received by the radio communication device (220). Alternatively, or in addition, one of the other methods described above for determining that the radio communication device (220) received the communication signal may be used. Subsequently, the microcontroller (210) activates the first actuator (215A) to press the “send” button on the satellite communication device (205), turning on the microphone of the satellite communication device (205). The communication signal is then transmitted from the radio communication device (220) to the satellite communication device (205) by continuing to project the voice signal from the speaker of the radio communication device (220) into the microphone of the satellite communication device (205). Afterwards, the satellite communication device (205) transmits the communication signal, received from the radio communication device (220), to another physically distant satellite communication device.

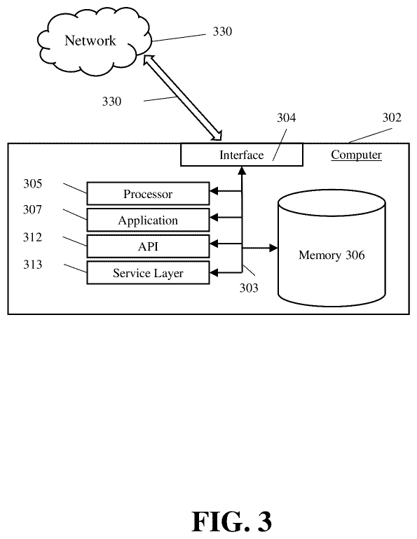

The microcontroller (210) may be part of a computer system or may be communicatively coupled to a computer system with a wired or wireless connection. FIG. 3 is a block diagram of a computer system (302) used to provide computational functionalities associated with described algorithms, methods, functions, processes, flows, and procedures as described in the instant disclosure, according to one or more embodiments.

The illustrated computer (302) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts.

Additionally, the computer (302) may include a computer that includes an input device, such as a keypad, keyboard, touch screen, or other device that may accept user information, and an output device that conveys information associated with the operation of the computer (302), including digital data, visual, or audio information (or a combination of information), or a GUI.

The computer (302) may serve in a role as a client, network component, a server, a database or other persistency, or any other component (or a combination of roles) of a computer system for performing the subject matter described in the instant disclosure. In some implementations, one or more components of the computer (302) may be configured to operate within environments, including cloud-computing-based, local, global, or other environment (or a combination of environments).

At a high level, the computer (302) is an electronic computing device operable to receive, transmit, process, store, or manage data and information associated with the described subject matter. According to some implementations, the computer (302) may also include or be communicably coupled with an application server, e-mail server, web server, caching server, streaming data server, business intelligence (BI) server, or other server (or a combination of servers).

The computer (302) may receive requests over network (330) from a client application (for example, executing on another computer (302) and responding to the received requests by processing the said requests in an appropriate software application. In addition, requests may also be sent to the computer (302) from internal users (for example, from a command console or by other appropriate access method), external or third-parties, other automated applications, as well as any other appropriate entities, individuals, systems, or computers.

Each of the components of the computer (302) may communicate using a system bus (303). In some implementations, any or all of the components of the computer (302), both hardware or software (or a combination of hardware and software), may interface with each other or the interface (304) (or a combination of both) over the system bus (303) using an application programming interface (API) (312) or a service layer (313) (or a combination of the API (312) and service layer (313). The API (312) may include specifications for routines, data structures, and object classes. The API (312) may be either computer-language independent or dependent and refer to a complete interface, a single function, or even a set of APIs. The service layer (313) provides software services to the computer (302) or other components (whether or not illustrated) that are communicably coupled to the computer (302). The functionality of the computer (302) may be accessible for all service consumers using this service layer. Software services, such as those provided by the service layer (313), provide reusable, defined business functionalities through a defined interface. For example, the interface may be software written in JAVA, C++, or other suitable language providing data in extensible markup language (XML) format or another suitable format. While illustrated as an integrated component of the computer (302), alternative implementations may illustrate the API (312) or the service layer (313) as stand-alone components in relation to other components of the computer (302) or other components (whether or not illustrated) that are communicably coupled to the computer (302). Moreover, any or all parts of the API (312) or the service layer (313) may be implemented as child or sub-modules of another software module, enterprise application, or hardware module without departing from the scope of this disclosure.

The computer (302) includes an interface (304). Although illustrated as a single interface (304) in FIG. 3, two or more interfaces (304) may be used according to particular needs, desires, or particular implementations of the computer (302). The interface (304) is used by the computer (302) to communicate with other systems in a distributed environment that are connected to the network (330). Generally, the interface (304) includes logic encoded in software or hardware (or a combination of software and hardware) and operable to communicate with the network (330). More specifically, the interface (304) may include software supporting one or more communication protocols associated with communications such that the network (330) or interface's hardware is operable to communicate physical signals within and outside of the illustrated computer (302).

The computer (302) includes at least one computer processor (305). Although illustrated as a single computer processor (305) in FIG. 3, two or more processors may be used according to particular needs, desires, or particular implementations of the computer (302). Generally, the computer processor (305) executes instructions and manipulates data to perform the operations of the computer (302) and any algorithms, methods, functions, processes, flows, and procedures as described in the instant disclosure. As described above, the computer processor (305) according to one or more embodiments of the disclosure may be a central processing unit (CPU). However, embodiments of the present disclosure are applicable to other types of processors that include SIMD registers as well.

The computer (302) also includes a memory (306) that holds data for the computer (302) or other components (or a combination of both) that may be connected to the network (330). The memory may be a non-transitory computer readable medium. For example, memory (306) may be a database storing data consistent with this disclosure. Although illustrated as a single memory (306) in FIG. 3, two or more memories may be used according to particular needs, desires, or particular implementations of the computer (302) and the described functionality. While memory (306) is illustrated as an integral component of the computer (302), in alternative implementations, memory (306) may be external to the computer (302).

The application (307) is an algorithmic software engine providing functionality according to particular needs, desires, or particular implementations of the computer (302), particularly with respect to functionality described in this disclosure. For example, application (307) may serve as one or more components, modules, applications, etc. Further, although illustrated as a single application (307), the application (307) may be implemented as multiple applications (307) on the computer (302). In addition, although illustrated as integral to the computer (302), in alternative implementations, the application (307) may be external to the computer (302).

There may be any number of computers (302) associated with, or external to, a computer system containing computer (302), wherein each computer (302) communicates over network (330). Further, the term “client,” “user,” and other appropriate terminology may be used interchangeably as appropriate without departing from the scope of this disclosure. Moreover, this disclosure contemplates that many users may use one computer (302), or that one user may use multiple computers (302).

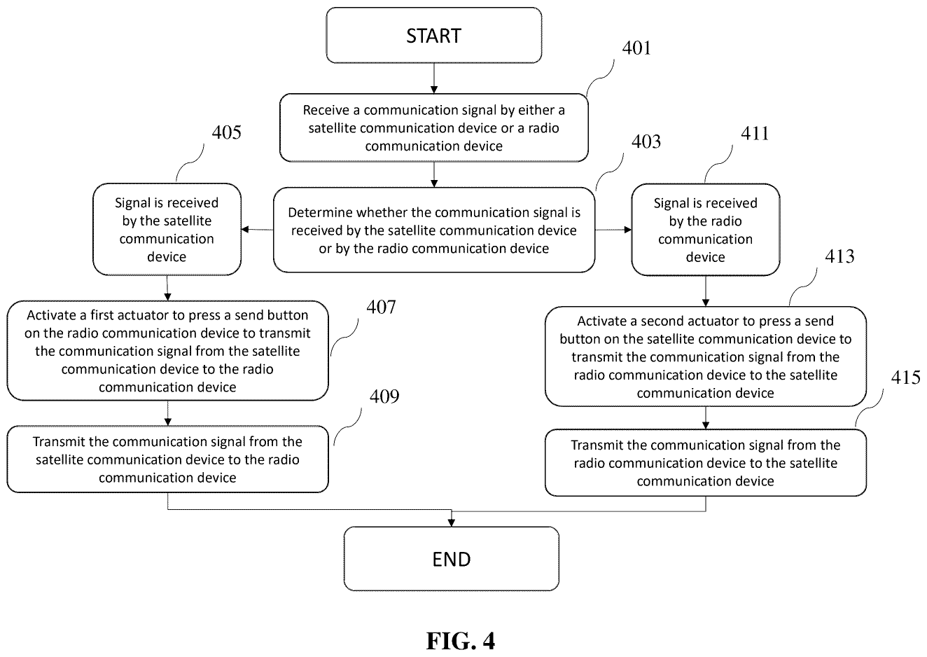

FIG. 4 depicts a method in the form of a flowchart in accordance with one or more embodiments. The steps of the method of FIG. 4 can be performed, at least in part, using the automation box (160) and the microcontroller (210). The steps may further be facilitated through use of a computer system, such as the computer system (302), that may be connected to the microcontroller (210).

In Step 401, a communication signal is received by either a satellite communication device (205) or a radio communication device (220). The satellite communication device (205) may be a satellite phone, and the radio communication device (220) may be handheld radio. If the communication signal is received by the satellite communication device (205), then the communication signal is a satellite communication signal (112). Alternatively, if the communication signal is received by the radio communication device (220), then the communication signal is a radio communication signal (122). The communication signal may be an audio signal, or may be processed into an audio signal, by one of the communication devices (205, 220). An example of an audio signal is a voice signal. The receiving communication device (205, 220) may project the audio signal from a speaker of the receiving communication device (205, 220).

In Step 403, a determination of whether the communication signal is received by the satellite communication device or by the radio communication device is made. Various examples above have been given with respect to different methods for determining whether the communication signal is received by the satellite communication device (205) or the radio communication device (220). For example, determining whether the communication signal is received by the satellite communication device (205) or by the radio communication device may include using a sound sensor (e.g., sound sensor (201A) or sound sensor (201B)) disposed in proximity to the satellite communication device (205) and the radio communication device (220), to detect the communication signal.

Alternatively, two sounds sensors may be used (sound sensors (201A, 201B)) to determine whether the communication signal is received by the satellite communication device or by the radio communication device. More specifically, a first sound sensor (201A) may be positioned nearer to the satellite communication device (205) than to the radio communication device (220), and a second sound sensor (201B) may be disposed nearer to the radio communication device (220) than to the satellite communication device (205), to detect the communication signal. A first time stamp indicating a first moment in time that the first sound sensor (201A) detects the communication signal may be recorded, and a second time stamp indicating a second moment in time that the second sound sensor (201B) detects the communication signal may be recorded. Then, a determination may be made of whether the first time stamp is earlier or later than the second time stamp. Consequently, it is determined that the communication signal is received by the satellite communication device (205) in response to the determination that the first time stamp is earlier than the second time stamp. Alternatively, it is determined that the communication signal is received by the radio communication device (220) in response to the determination that the first time stamp is later than the second time stamp.

Instead of using one or more sound sensors (201A, 201B), or in addition to using one or more sound sensors (201A, 201B), a light detector or a vibration detector may be used according to the description provided above in reference to FIG. 2 to determine whether the communication signal is received by the satellite communication device or by the radio communication device. After Step 403, there are generally two possibilities, Step 405 or Step 411.

In Step 405, it is determined that the communication signal is received by the satellite communication device. Subsequently, in Step 407, a second actuator (215B) is activated to press a send button on the radio communication device (220) to transmit the communication signal from the satellite communication device (205) to the radio communication device (220). After the send button on the radio communication device (220) has been pressed, the communication signal is transmitted from the satellite communication device (205) to the radio communication device (220) in Step 409. In a step not shown, the radio communication device (220) may then transmit the communication signal, received from the satellite communication device, to a physically distant radio communication device.

In one or more embodiments where the communication is an audio signal, or where the communication signal is processed into an audio signal (e.g., a voice signal), then the following steps may be included. Transmitting the audio signal from the satellite communication device (205) to the radio communication device (220) may include projecting the audio signal from the speaker of the satellite communication device (205) into a microphone of the radio communication device (220). The microphone of the radio communication device (220) may be turned on by pressing the “send” button on the radio communication device (220) using the second actuator (215B), after it has been determined that a communication signal is received by the satellite communication device (205).

In Step 411, it is determined that the communication signal is received by the radio communication device. Subsequently, in Step 413, a first actuator (215A) is activated to press a send button on the satellite communication device to transmit the communication signal from the radio communication device to the satellite communication device. After the send button on the satellite communication device has been pressed, the communication signal is transmitted from the radio communication device to the satellite communication device in Step 415. In a step not shown, the satellite communication device (205) may then transmit the communication signal, received from the radio communication device, to a physically distant satellite communication device.

In one or more embodiments where the communication is an audio signal, or where the communication signal is processed into an audio signal (e.g., a voice signal), then the following steps may be included. Transmitting the voice signal from the radio communication device (220) to the satellite communication device (205) may include projecting the voice signal from the speaker of the radio communication device (220) into a microphone of the satellite communication device (205). The microphone of the satellite communication device (205) may be turned on by pressing the “send” button on the satellite communication device (205) using the first actuator (215A), after it has been determined that a communication signal is received by the radio communication device (220).

The method of FIG. 4 can be executed repeatedly (e.g., in a loop) to continually exchange communication signals between the satellite communication device (205) and the radio communication device (220). Accordingly, Step 401 of receiving a communication signal by either the satellite communication device (205) or the radio communication device (220) may be performed again immediately after either Step 409, transmitting the communication signal from the satellite communication device (205) to the radio communication device (220), or immediately after Step 415, transmitting the communication signal from the radio communication device (220) to the satellite communication device (205).

In the method illustrated by FIG. 4, the first actuator (215A), the second actuator (215B), and the sound sensor (201A, 201B) may be wirelessly controlled by the microcontroller (210). In addition, as described in reference to FIG. 2, the satellite communication device (205), the radio communication device (220), the first actuator (215A), the second actuator (215B), the sound sensor (201A, 201B), and the microcontroller (210), may be mechanically integrated in a box, referred to as the automation box (160).

Embodiments of the disclosure have one or more of the following advantages. For example, embodiments of the present disclosure provide an automated process for operating a communication midpoint in between locations that use incompatible communication methods, such as a remote location that uses a satellite communication system and another location that uses a radio communication system. By providing operation methods and systems that are automated, businesses and investors may save costs associated with constantly requiring the presence of a human operator at the communication midpoint. In addition, embodiments of the present disclosure provide for real-time of exchanging data between the locations that use the incompatible communication methods. By contrast, alternative methods that rely on the use of a human operator are slow and do not allow for the real-time exchange of data because the human operator must manually receive a message through one communication system and then manually transmit the message to the other communication system. Yet further, embodiments of the present disclosure eliminate error in message passing introduced by human involvement.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A system, comprising:
a satellite communication device;
a radio communication device;
wherein the radio communication device and the satellite communication device are each configured to receive a communication signal;
a first actuator mechanically coupled to the satellite communication device;
a second actuator mechanically coupled to the radio communication device; and
a microcontroller configured to:
determine whether the communication signal is received by the satellite communication device or by the radio communication device,
in response to the determination that the communication signal is received by the satellite communication device:
activate the second actuator to press a send button on the radio communication device to transmit the communication signal from the satellite communication device to the radio communication device, and
transmit the communication signal from the satellite communication device to the radio communication device, and
in response to the determination that the communication signal is received by the radio communication device:
activate the first actuator to press a send button on the satellite communication device to transmit the communication signal from the radio communication device to the satellite communication device, and
transmit the communication signal from the radio communication device to the satellite communication device.

2. The system of claim 1, wherein the communication signal is a voice signal.

3. The system of claim 2, wherein:
transmitting the voice signal from the satellite communication device to the radio communication device comprises projecting the voice signal from a speaker of the satellite communication device into a microphone of the radio communication device; and
transmitting the voice signal from the radio communication device to the satellite communication device comprises projecting the voice signal from a speaker of the radio communication device into a microphone of the satellite communication device.

4. The system of claim 1, further comprising a sound sensor disposed in proximity to the satellite communication device and the radio communication device, wherein determining whether the communication signal is received by the satellite communication device or by the radio communication device comprises:
using the sound sensor to detect the communication signal.

5. The system of claim 1, further comprising two sound sensors, a first sound sensor disposed nearer to the satellite communication device than to the radio communication device, and a second sound sensor disposed nearer to the radio communication device than to the satellite communication device, wherein determining whether the communication signal is received by the satellite communication device or by the radio communication device comprises:
recording a first time stamp indicating a first moment in time that the first sound sensor detects the communication signal and a second time stamp indicating a second moment in time that the second sound sensor detects the communication signal;
determining whether the first time stamp is earlier or later than the second time stamp; and
determining that the communication signal is received by the satellite communication device in response to the determination that the first time stamp is earlier than the second time stamp; or
determining that the communication signal is received by the radio communication device in response to the determination that the first time stamp is later than the second time stamp.

6. The system of claim 4, wherein the first actuator, the second actuator, and the sound sensor are wirelessly controlled by the microcontroller.

7. The system of claim 6, wherein the satellite communication device, the radio communication device, the first actuator, the second actuator, the sound sensor, and the microcontroller, are mechanically integrated in a box.

8. The system of claim 1, wherein the satellite communication device is a satellite phone, and the radio communication device is a handheld radio.

9. The system of claim 1, wherein the satellite communication device is configured to transmit the communication signal, received from the radio communication device, to a physically distant satellite communication device.

10. The system of claim 1, wherein the radio communication device is configured to transmit the communication signal, received from the satellite communication device, to a physically distant radio communication device.

11. A method, comprising:
receiving a communication signal by either a satellite communication device or a radio communication device;
determining whether the communication signal is received by the satellite communication device or by the radio communication device;
in response to the determination that the communication signal is received by the radio communication device:
activating a first actuator to press a send button on the satellite communication device to transmit the communication signal from the radio communication device to the satellite communication device, and
transmitting the communication signal from the radio communication device to the satellite communication device, and
in response to the determination that the communication signal is received by the satellite communication device:
activating a second actuator to press a send button on the radio communication device to transmit the communication signal from the satellite communication device to the radio communication device, and
transmitting the communication signal from the satellite communication device to the radio communication device.

12. The method of claim 11, wherein the communication signal is a voice signal.

13. The method of claim 12, wherein:
transmitting the voice signal from the satellite communication device to the radio communication device comprises projecting the voice signal from a speaker of the satellite communication device into a microphone of the radio communication device; and
transmitting the voice signal from the radio communication device to the satellite communication device comprises projecting the voice signal from a speaker of the radio communication device into a microphone of the satellite communication device.

14. The method of claim 11, wherein determining whether the communication signal is received by the satellite communication device or by the radio communication device comprises:
using a sound sensor, disposed in proximity to the satellite communication device and the radio communication device, to detect the communication signal.

15. The method of claim 11, wherein determining whether the communication signal is received by the satellite communication device or by the radio communication device comprises:
using two sound sensors, a first sound sensor disposed nearer to the satellite communication device than to the radio communication device, and a second sound sensor disposed nearer to the radio communication device than to the satellite communication device, to detect the communication signal;
recording a first time stamp indicating a first moment in time that the first sound sensor detects the communication signal and a second time stamp indicating a second moment in time that the second sound sensor detects the communication signal;
determining whether the first time stamp is earlier or later than the second time stamp; and
determining that the communication signal is received by the satellite communication device in response to the determination that the first time stamp is earlier than the second time stamp; or
determining that the communication signal is received by the radio communication device in response to the determination that the first time stamp is later than the second time stamp.

16. The method of claim 14, wherein the first actuator, the second actuator, and the sound sensor are wirelessly controlled by a microcontroller.

17. The method of claim 16, wherein the satellite communication device, the radio communication device, the first actuator, the second actuator, the sound sensor, and the microcontroller, are mechanically integrated in a box.

18. The method of claim 11, wherein the satellite communication device is a satellite phone, and the radio communication device is a handheld radio.

19. The method of claim 11, further comprising transmitting, by the satellite communication device, the communication signal received from the radio communication device to a physically distant satellite communication device.

20. The method of claim 11, further comprising transmitting, by the radio communication device, the communication signal received from the satellite communication device to a physically distant radio communication device.
